(19) United States
(12) Patent Application Publication
(10) Pub. No.: US 2008/0171626 A1
(43) Pub. Date: Jul. 17, 2008

(54) HYDROMECHANICAL TRANSMISSION WITH OUTPUT SUMMER

(75) Inventor: Frederic W. Pollman, Eden Prairie, IA (US)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/623,583

(22) Filed: Jan. 16, 2007

(51) Int. Cl. F16H 47/04

(52) U.S. Cl. 475/73

(57) ABSTRACT

A hydromechanical transmission having at least first and second three element planetaries directly connected to one another. The first and second three element planetaries work in conjunction with a hydrostatic transmission and a plurality of clutches in order to provide at least first and second forward operating modes having continuous ratios.

### BACKGROUND OF THE INVENTION

This invention relates to a hydromechanical transmission. More specifically this invention relates to a hydromechanical transmission with output summer allowing for multiple operating modes having continuous ratios.

There are number of work vehicles that desire to have continuous ratio transmissions with high efficiency for maximum power delivery to the wheels and for high fuel economy. These include tractors, loaders, utility vehicles and trucks. These vehicles also have requirements for low cost and good controllability through the entire speed range.

Hydromechanical transmissions are characterized by a hydrostatic transmission power path and parallel with the mechanical power transmission path, arranged in a manner to decrease the average power flow through the hydrostatic portion and thereby increase operating efficiency. Typically, the mechanical power path includes a planetary gear set which acts to sum the power flows at either the input or output end of the transmission. The existence of parallel power paths creates the possibility of reducing the output speed range or torque ratio in order to further reduce transmitted hydrostatic power; this then requires multiple ranges or “modes” to achieve the full torque and speed range of the transmission. The impact of multiple modes is to improve efficiency and sometimes to reduce costs. In addition to efficiency and cost, the magnitude of the output speed range/torque ratio in each mode has an impact on input power capacity relative to the size of the hydrostatic transmission. Smaller ratios allow larger input power for the same size hydraulic units. Specifically the more modes allow either smaller mode ratios or larger transmission ratios or both.

Therefore a principal object of the principal invention is to provide a hydromechanical transmission with multiple modes that increases the transmission efficiency.

Yet another object of the present invention is to provide an improved hydromechanical transmission having a versatile design configuration.

These and other objects, features, or advantages of the present invention will become apparent from the specification and claims.

### BRIEF SUMMARY OF THE INVENTION

A hydromechanical transmission having a first planetary with first, second and third elements and a second planetary with first, second and third elements wherein the second element of the second planetary is connected to the first element of the first planetary. The hydromechanical transmission additionally had a first clutch connected to the first element of the second planetary and the third element of the first planetary and has a second clutch that is connected to the first element of the second planetary. These first and second plantaries and first and second clutches can then be sequentially engaged to create first and second forward operating modes for the transmission. Additionally a reverse clutch can be connected to the first element of the second planetary to provide a reverse operating mode and to provide operating modes from reverse through forward all having continuous ratio.

### BRIEF DESCRIPTION OF THE DRAWINGS

FIG. 1 is a schematic diagram of a hydromechanical transmission;

FIG. 2 is a block diagram of the hydromechanical transmission of claim 1;

FIG. 3 is a speed diagram of the hydromechanical transmission of FIG. 1;

FIG. 4 is a schematic diagram of a hydromechanical transmission having three plantaries;

FIG. 5 is a block diagram of the hydromechanical transmission shown in FIG. 4;

FIG. 6 is a speed diagram of the hydromechanical transmission shown in FIG. 4;

FIG. 7 is a schematic diagram of a hydromechanical transmission having two planetaries;

FIG. 8 is a block diagram of the hydromechanical transmission of FIG. 7; and

FIG. 9 is a speed diagram of the hydromechanical transmission of FIG. 7.

### DETAILED DESCRIPTION OF THE PREFERRED EMBODIMENT OF THE INVENTION

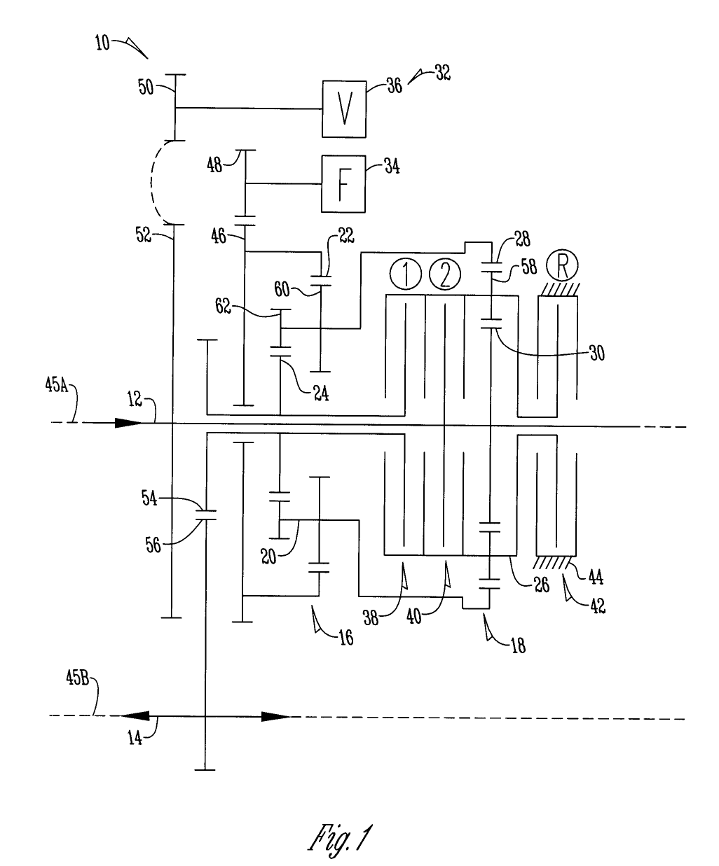

FIGS. 1-3 relate to a first embodiment of a hydromechanical transmission (HMT) 10. The hydromechanical transmission 10 has an input shaft 12 and an output shaft 14 wherein the input shaft extends through the hydromechanical transmission 10 and acts as a power take off (PTO) shaft. Altering the input 12 to arrive at output 14 are first and second planetaries 16 and 18.

In a preferred embodiment first planetary 16 is a three element planetary wherein the first element 20 of the first planetary 16 is a planet carrier, the second element 22 of the first planetary is a ring gear and the third element 24 of the first planetary is a sun gear. Similarly in a preferred embodiment the second planetary 18 additionally has first, second and third elements 26, 28 and 30 wherein the first element 26 of the second planetary 18 also is a planet carrier, the second element 28 of the second planetary 18 is a ring gear and the third element 30 of the second planetary 18 is a sun gear. Preferably, the highest speed element is the third element 24 of the first planetary 16 (a sun gear) to minimize high speed rotating mass.

The hydromechanical transmission 10 additionally comprises a hydrostatic transmission 32 having first and second hydrostatic units 34 and 36 that in a preferred embodiment are fixed unit 34 and variable unit 36. The hydromechanical transmission 10 also has first and second clutches 38 and 40 and a reverse clutch 42 that can be connected to a brake 44.

In this embodiment the hydromechanical transmission 10 is configured such that the second planetary 18 is on an input 12 center line 45a. Alternatively, the second planetary 18 could also be located on output center line 45b with appropriate gears. Additionally in this embodiment the first and second clutches 38 and 40 and reverse clutch 42 are configured to be adjacent to each other on the same center line 45a or 45b as the second planetary 18. The input and output 12 and 14 preferably are on adjacent and parallel center lines 45a and 45b to match vehicle requirements. The input center line 45a, first and second planetary 16 and 18, and the clutch 38, 40, 42 arrangement allows the through PTO drive of the input shaft 12. The output center line 45b allows a through output shaft 14 for both front and rear drive shafts and axles, even if the second planetary 18 and the clutches 38, 40, 42 are on the output center line 45b. The clutches 38, 40, 42 are adjacent to each other for ease of routing the power supply to them.

The components of the hydromechanical transmission 10 are connected with a plurality of gear sets. Specifically the hydrostatic transmission 32 is connected to the second element 22 of the first planetary 16 with a gear set having gears 46 and 48. The hydrostatic transmission 32 additionally is connected to the input 12 via gear set having gears 50 and 52. Also a third gear set having gears 54 and 56 connect the output 14 to the third element 24 of the first planetary 16. Additional gears within the transmission are gears of the first and second planetary and specifically are planet gear 58 and double planet gears 60 and 62.

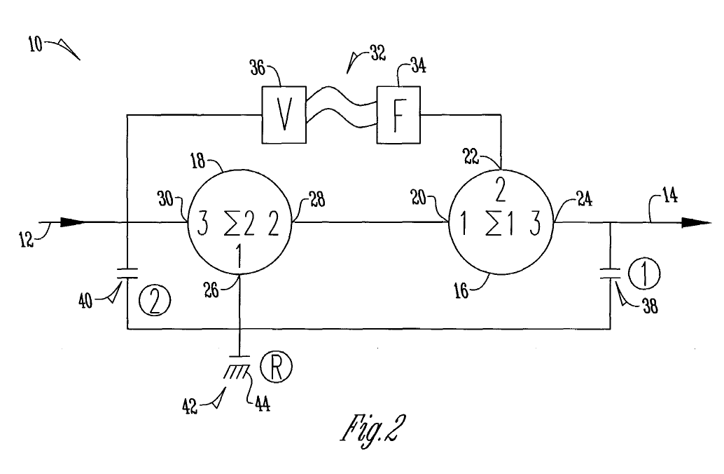

In light of the gearing, the connections of the hydromechanical transmission 10 are best shown by the block diagram of FIG. 2. Specifically, in relation to the first and second planetaries 16 and 18, the first element 20 of the first planetary 16 is connected to the second element 28 of the second planetary 18. The second element 22 of the first planetary 16 is connected to the fixed unit 34 of hydrostatic transmission 32. The third element 24 of the first planetary 16 is connected to the output 14 and first clutch 38. Meanwhile regarding the second planetary 18 the first element 26 of the second planetary 18 is connected to the first and second clutches 38 and 40 and additionally is connected to reverse clutch 42. As discussed the second element 28 of the second planetary 18 is connected to the first element 20 of the first planetary 16. Finally the third element 30 of the second planetary 18 is connected to the variable unit 36 of the hydrostatic transmission 32, the input 12, and the second clutch 40.

In a first forward operating mode, or mode 1, the first clutch 38 connects the third element 24 of the first planetary 16 to the first element 26 of the second planetary 18 creating a four element planetary. In a second forward operating mode, or mode 2, the second clutch 40 connects the first element 26 of the second planetary 18 to the third element 30 of the second planetary 18 to lock up the second planetary 18 at input speed. Because the second clutch 40 locks up the second planetary 18 it can be connected between any two of the first, second and third elements 26, 28 and 30 of the second planetary 18.

In a reverse operating mode (reverse mode), the first element 26 of the second planetary 18 is connected to ground 44 which prevents rotation of the first element 26 of second planetary 18. The first planetary 16 and the four element planetary created when the first clutch 38 is engaged are output summers as the input 12 is connected to variable unit 36 and output 14 is connected only to one element of the first planetary 16. Variable unit 36 operates at input speed and changes displacement from full negative to full positive and then reverses displacement change for the next mode. This causes the fixed unit 34 and the second element 22 of the first planetary 16 to change from full negative to full positive speed in mode 1 and reverse mode, and from full positive to full negative in mode 2.

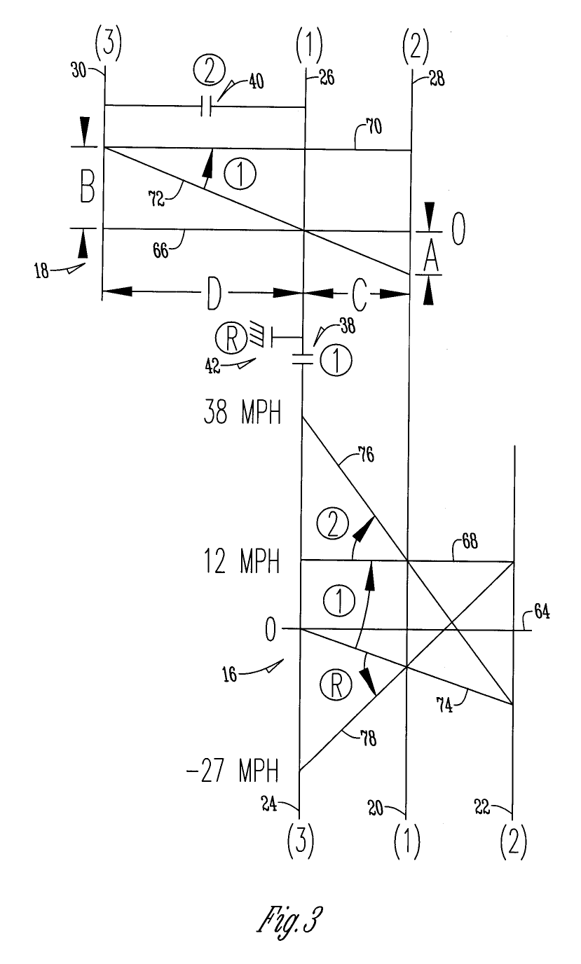

FIG. 3 is a speed diagram for first and second plantaries 16 and 18. The speed diagram provides the speed relationships for all the elements of the planetaries 16 and 18. Specifically the vertical axis of the diagram represents speed of the first, second and third elements 20, 22 and 24 of the first planetary 16 and of the first, second and third elements 26, 28 and 30 of the second planetary 18. Meanwhile the horizontal lines represent planetary ratio. For example, line 64 represents zero miles per hour of the first planetary whereas line 66 represents zero miles per hour for the second planetary. Similarly, line 68 provides a speed for the first planetary 16 at an arbitrary 12 miles per hour whereas line 70 shows the same 12 miles per hour for the second planetary 18.

Thus the length between the vertical axis lines represents the ratio of the planetary gears. By example, if vertical axis 28 is a ring gear, axis 26 is a planet carrier and axis 30 a sun, then the ratio D/C represents the ratio of ring teeth to sun teeth. If the speed of element 26 was zero, and the ratio D/C was −2 then the ratio B/A would be −2 as shown with line 72. Therefore, sun speed would be twice ring speed and in the opposite direction. The speed diagram is enhanced with locations of clutches and is shown with the output speed positive for forward direction.

When referencing the speed diagram of FIG. 3, mode 1 starts with the first clutch 38 engaged and the third element 24 of the first planetary 16 and the first element 26 of the second planetary 18 at zero speed. As illustrated by line 72, which is coincident with line 74, the third element 30 of the second planetary 18 is at input speed which puts the second element 22 of the first planetary 16 and connected fixed unit 34 at near maximum negative speed. As variable unit 36 is connected to the input 12 the unit 36 is near maximum positive speed. Line 64 is the zero speed axis. When a controller causes variable unit 36 to change the ratio of the hydromechanical transmission 10 and drive forward, the second element 22 of the first planetary 16 slows down and approaches zero, and then speeds up positively as shown by line 68 and coincident line 70. The pivot point for the speed diagram is the third element 30 of the second planetary 18 operating at input speed. Output 14 speeds up in a positive direction as shown by line 68. At maximum speed in mode 1, the second mode clutch 40 elements are near synchronous speed.

As mode 2 is engaged with clutch 40 and the first clutch 38 is disengaged the second planetary 18 is locked up and the function is changed to provide an input speed pivot point at the first element 20 of first planetary 16. The variable unit 36 reverses its displacement, reversing the direction of speed change for fixed unit 34, causing the second element 22 of the first planetary 16 to reverse its direction. This raises the speed of the third element 24 of the first planetary 16 to its maximum as shown by line 76, raising output speed to its maximum in mode 2.

The reverse mode is obtained by engaging the reverse clutch 42 at near zero output speed which is also near synchronous speed for the reverse clutch 42 and the first clutch 38 is then disengaged. This fixes the speed of the second element 28 of the second planetary 18 at a negative value, allowing the first element 20 of first planetary 16 to pivot on a negative speed. This causes the third element 24 of the first planetary 16 to increase in reverse speed as the second element 22 of the first planetary 16 increases in a positive direction driven by fixed unit 34. Maximum reverse speed is shown by line 78 at vertical axis 24.

Continuous power is delivered from the engine to the wheels, with continuous ratio change, from full reverse to full forward speed even though the transmission changes modes at zero speed and between zero and maximum forward speed. For downshifts, the process is reversed. Transmission control functions may be accomplished in a manner similar to that in U.S. Pat. No. 5,560,203 or by other suitable control means. Depending on the vehicle requirements, mode 2 or reverse mode could be eliminated by omitting the second clutch 40 or reverse clutch 42.

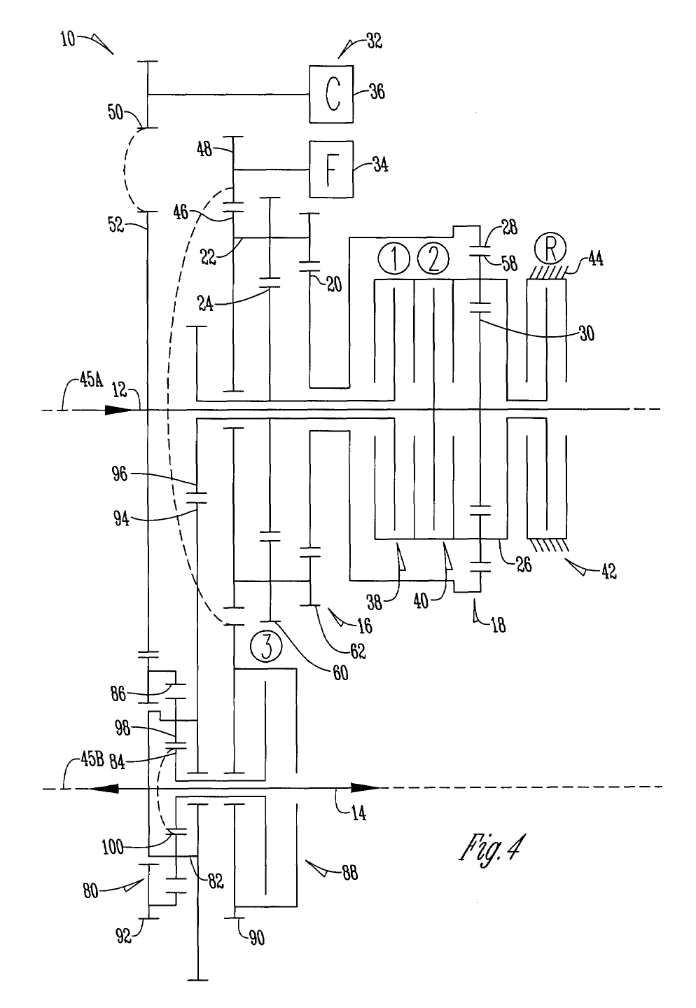

FIGS. 4-6 provide an alternative embodiment of the hydromechanical transmission 10. Specifically, as shown in schematic FIG. 4, a third planetary 80 having first, second and third elements 82, 84 and 86 is connected via third clutch 88 to the hydromechanical transmission of FIGS. 1-3. In a preferred embodiment the first element 82 of the third planetary 80 is a planet carrier, the second element 84 of the third planetary 80 is a sun gear, and the third element 86 of the third planetary 80 is a ring gear. The highest speed element is still a sun gear 24 in order to minimize rotating mass. To connect the third planetary 82 to the hydromechanical transmission 10 a plurality of gears and gear sets are provided. Specifically a gear 90 works in combination with gears 46 and 48 to create a positive ratio gear set. Gear 92 works in association with gear 52 to also create a negative ratio gear set. Also, gears 94 and 96 are added to the hydromechanical transmission 10 to provide a negative ratio gear set. Additionally planet gears 98 and 100 are provided to provide the needed connections.

The gear and clutch schematic of FIG. 4 is configured to achieve several objectives in the layout of the transmission. The input and output are on adjacent and parallel center lines 45a and 45b to match vehicle requirements. The input center line 45a arrangement allows the input shaft 12 to provide a through PTO drive. The output center line 45b arrangement allows a through drive for both front and rear drive shafts and axles. The layout of the gears along with clutches and hydrostatic units allow a third forward operating mode to be included as an add-on with the same basic two mode transmission.

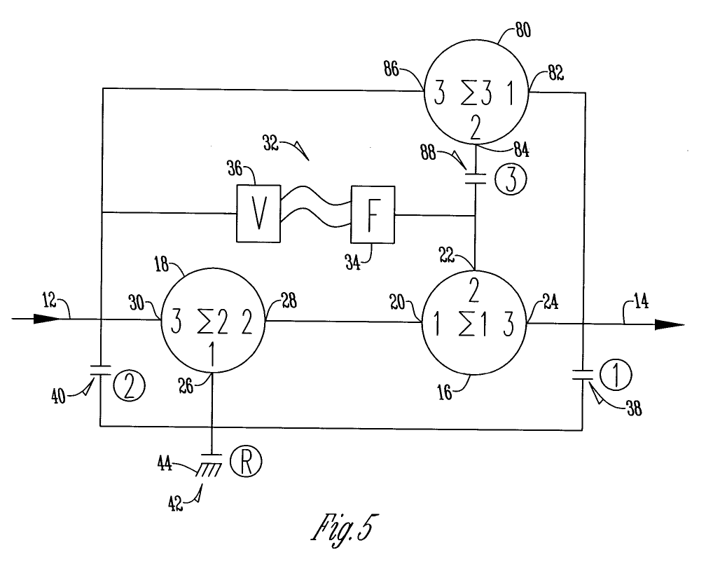

The result of the gearing as shown in FIG. 4 is best shown in the block diagram of FIG. 5. Specifically added to the hydromechanical transmission 10 is the third planetary 80. Third planetary 80 has a first element 82 that is connected to the third element 24 of the first planetary 16, to the first clutch 38 and to the output 14. The second element 84 of the third planetary 80 is connected to a third clutch 88 that when engaged connects the second element 84 of third planetary 80 to the second element 22 of the first planetary 16 and to the fixed unit 34 of hydrostatic transmission 32. The third element 86 of the third planetary 80 is connected to the variable unit 36 of the hydrostatic transmission 32, to the input 12, to the third element 30 of the second planetary 18 and to the second clutch 40. Thus by engaging the third clutch 88, a third forward operating mode (mode 3) is created that has a continuous ratio.

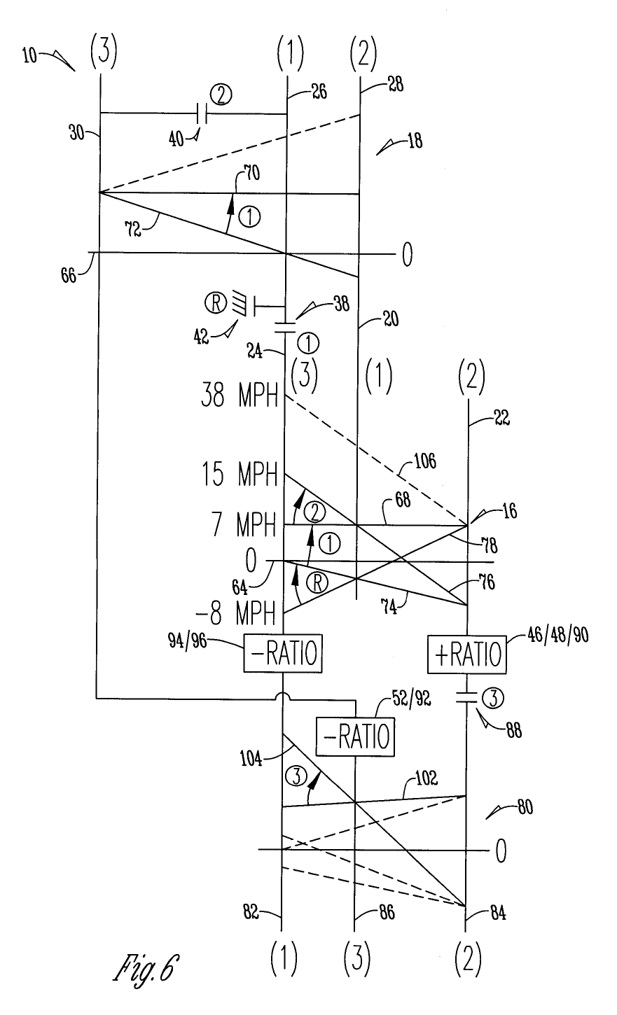

FIG. 6 shows the speed diagram of FIG. 3 with the added third planetary 80 such that first, second and third elements 82, 84 and 86 of the third planetary 80 are represented on the vertical axes. Again the speed diagram is enhanced with the locations of clutches and negative and positive gear ratios. A negative ratio indicates that the relative direction of rotation for the planetaries is opposite. The speed diagrams are all shown with the output speed positive for forward direction even though the actual direction of rotation is opposite for a negative gear ratio. At maximum speed in mode 2, the ratios 96/94, 52/92 and 46/48/90 are configured to have the third mode clutch elements at near synchronous speeds.

As mode 3 is engaged with the third clutch 88, the function of the third planetary 80 is power splitting and allows variable unit 36 to reverse displacement and increase the speed of the output 14 to its maximum value. However, the second element of the third planetary 80 now changes speed in the same direction as the second element 22 of the first planetary 16 as it is now connected with positive gear ratio 46/48/90. (Note that this appears as the opposite direction in the speed diagram in FIG. 6 because the drawing convention is to keep forward output speed always positive). Starting from line 102 as the fixed unit 34 decreases speed, the second element 84 of third planetary 80 decreases speed raising the output speed of the first element 82 of the third planetary 80 as shown by line 104. As the third element 24 of the first planetary 16 is connected to the first element 82 of the third planetary 80, it also raises output speed of the output shaft 14 to the maximum value as shown by line 106. Continuous power is delivered from the engine to the wheels, with continuous ratio change, from full reverse to full forward speed even though the transmission changes modes at zero speed and changes twice between zero and maximum forward speed.

Alternate speed diagrams are possible to achieve the same relationship between the input shaft 12 and output shaft 14 speeds. For instance, the third element 86 of the third planetary 80 could be located on the opposite side of the second element 84 of the third planetary 80 from the first element 82 of the third planetary 80. This would require a positive ratio of gears 52/92 and a negative ratio of gears 46/48/90. The speed diagram needs only to meet the requirements for input speed versus output speed, and to achieve the required shift points without exceeding limitations on planetary element speed, reasonable gear ratios and economy of parts. This change would not affect the block diagram of FIG. 5.

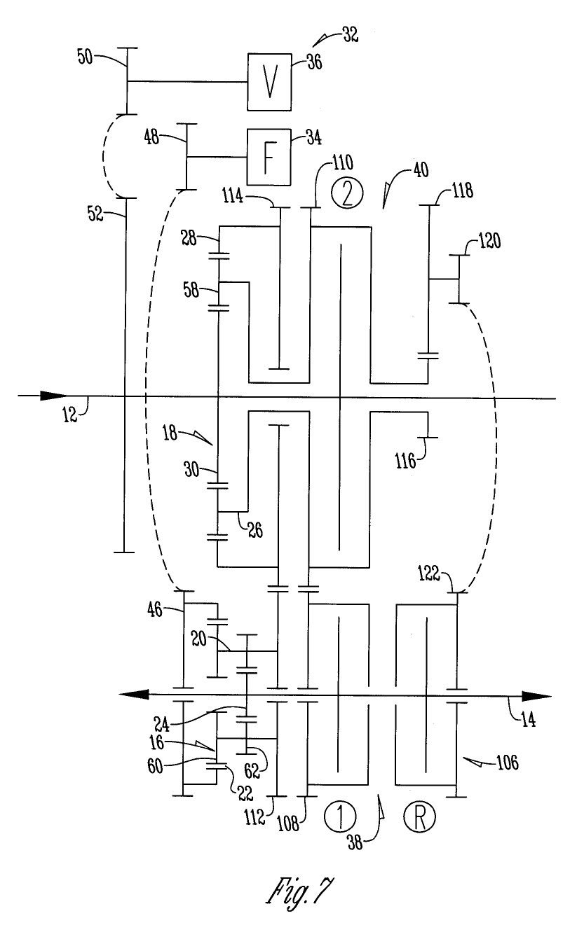

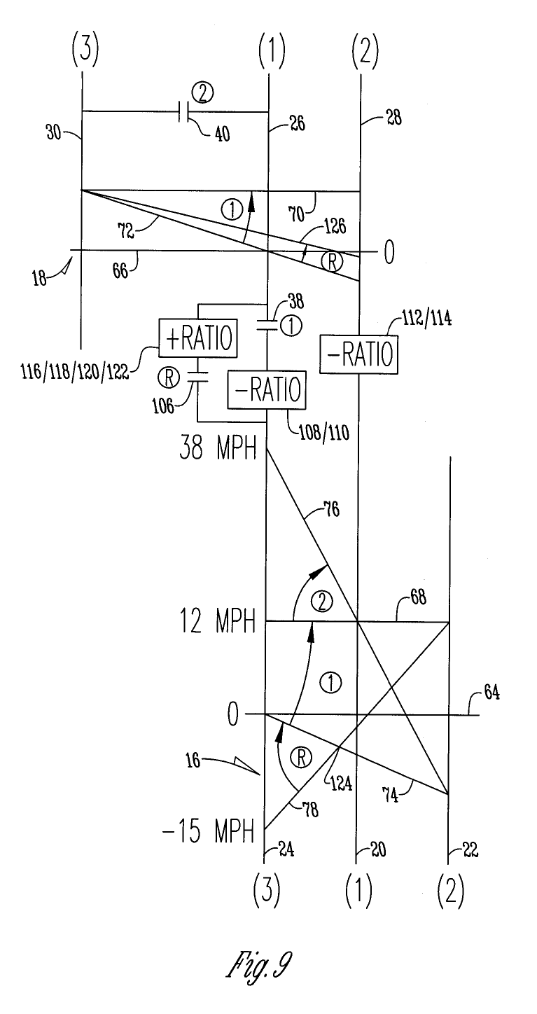

FIGS. 7, 8 and 9 show an alternate embodiment of the hydromechanical transmission 10 of FIGS. 1-3. Specifically as best shown in the schematic of FIG. 7, the reverse clutch 106 is not grounded. To accomplish this as shown in the schematic, multiple gear sets are again added to the hydromechanical transmission 10. Specifically a gear set having gears 108 and 110 wherein the gear set has a negative ratio and is used to connect first element 26 of the second planetary and the third element 24 of the first planetary 16 in combination with the first clutch 38. Meanwhile the second element 28 of the second planetary 18 and the first element 20 of the first planetary 16 are connected with a gear set having gears 112 and 114 that have a negative ratio. Meanwhile the first element 26 of the second planetary 18 and third element 24 of the first planetary 16 are connected by the reverse clutch 106 and a gear set having gears 116, 118, 120 and 122 that have a positive ratio, the opposite sign of gear sets 108/110 and 112/114. If the sign of gear ratio of 116/118/120/122 is the same as for the gear ratio of gear set 108/110 and 112/114, maximum reverse speed is higher than for the opposite sign of this ratio. The use of gear ratio 116/118/120/122 between the output shaft 14 and a first element 26 of the second planetary 18 creates a virtual pivot point 124 (FIG. 9) that is not coincident with any planetary element.

Input shaft 12 is offset and parallel to output shaft 14. The first planetary 16 is located on the output shaft center line 45b while the second planetary is on the input center line 45a. The first planetary 16 could also be located on the input center line 45a by eliminating gear sets 108/110 and 112/114. If both the first and second planetaries 16 and 18 were on the input center line, there would be an additional idler in gear set 116/118/120/122 in order to make the ratio negative. Regardless, the first clutch 38 and reverse clutch 106 are adjacent to each other on the same center line as the first planetary 16.

Therefore, the input 12 and output 14 are on adjacent and parallel center lines 45a and 45b to match vehicle requirements. The input center line 45a, the second planetary 18, and the clutch arrangement allows a through PTO drive of the input shaft 12. The arrangement of the first planetary 16 and first clutch 38 and reverse clutch 106 allows a through output shaft 14 for both front and rear drive shafts and axles. As with previous embodiments, the highest speed element is a sun gear 24 to minimize high speed rotating mass. A third forward operating mode could be added to the transmission of FIGS. 7-9 in a manner similar to that shown in FIGS. 4-6.

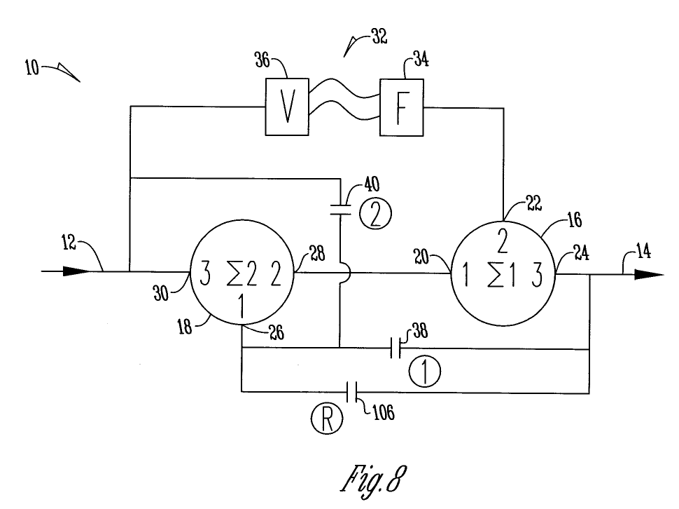

Thus as best shown in the block diagram of FIG. 8, in this embodiment the first element 20 of the first planetary 16 is connected to the second element 28 of the second planetary 18. The second element 22 of the first planetary 16 is connected to the fixed unit 34. The third element 24 of the first planetary 16 is connected to the output shaft 14, the first clutch 38, and the reverse clutch 106. In a preferred embodiment the reverse clutch 106 is connected to the third element 24 of the first planetary 16 with a reducing gear. Meanwhile, the first element 26 of the second planetary 18 is connected to the first and second clutches 38 and 40 and the reverse clutch 106. As mentioned, the second element 28 of the second planetary 18 is connected to the first element 20 of the first planetary 16. The third element 30 of the second planetary 18 is connected to the input shaft 12, the second clutch 40 and the variable unit 36.

With reference to FIG. 9, mode 1 starts with the first clutch 38 engaged and the third element 24 of the first planetary 16 and the first element 26 of the second planetary 18 at zero speed. As illustrated by line 72, which is coincident with line 74, the third element 30 of the second planetary 18 is at input speed that puts the second element 22 of the first planetary 16 and connected fixed unit 34 at near maximum negative speed. As variable unit 36 is connected to the input, it is near maximum positive speed and full displacement. Line 64 is the zero speed axis. When a controller causes variable unit 36 to change the ratio of the hydromechanical transmission and drive forward, the second element 22 of the first planetary 16 slows down and approaches zero, and then speeds up positively as shown by line 68 at axis 22 and coincident line 70. Output 14 speeds up in a positive direction as shown by line 68. At maximum speed of mode 1, the second forward operating mode clutch elements are near synchronous speed.

As the second forward operating mode 2 is engaged with the second clutch 40, second planetary 18 is locked up and the function is changed to provide an input speed pivot point for the first element 20 of the first planetary 16. Variable unit 36 reverses its displacement, reversing the direction of speed change for fixed unit 34, causing the second element 22 of first planetary 16 to reverse its direction. This raises the speed of third element 24 of first planetary 16 to its maximum as shown by line 76, raising output 14 speed to its maximum in mode 2.

Reverse speed is obtained by engaging the reverse clutch 106 at near zero output speed which is also near synchronous speed for the reverse clutch 106. As the second element 22 of the first planetary 16 slows down in a negative direction, the third element 24 of the first planetary 16 goes from zero speed to a negative speed. As the first element 26 of the second planetary 18 is geared to the third element 24 of the first planetary 16 with gear set having a ratio 116/118/120/122, it changes speed also. This speed change from zero of the first element 26 of the second planetary 18 can be either positive or negative, depending on the sign of ratio 116/118/120/122.

In FIG. 9 the second element 28 of the second planetary 18 is decreasing negative speed as shown by line 126. As the second element 28 of the second planetary 18 is a pivot point for the speed diagram when the first planetary 16 is changing speed in reverse, its speed change results in a shift of the actual pivot point. Thus the maximum speed of the third element 24 of the first planetary 16 is a variable depending on ratio 116/118/120/122. Increasing negative ratio for 116/118/120/122 results in decreasing maximum speed for reverse. Increasing positive ratio 116/118/120/122 results in increasing maximum speed for reverse. As the second element 22 of the first planetary 16 increases speed in a positive direction, maximum reverse speed is achieved shown by line 78 at axis 24.

Thus disclosed is an improved hydromechanical transmission that uses planetaries to provide for multiple operating modes. The disclosed transmission is not only efficient but additionally cost effective and at the very least meets all of the stated objectives.

It will be appreciated by those skilled in the art that other various modifications could be made to the device without the parting from the spirit in scope of this invention. All such modifications and changes fall within the scope of the claims and are intended to be covered thereby.

What is claimed is:

1. A hydromechanical transmission comprising:
a first planetary having first, second and third elements;
a second planetary having first, second and third elements connected to the first planetary;
a hydrostatic transmission connected to the first and second planetaries;
a first clutch connected to the first element of the second planetary and the third element of the first planetary;
a second clutch connected to the first element of the second planetary; wherein the clutches are sequentially engaged to create first and second forward operating modes.

2. The hydromechanical transmission of claim 1 further comprising:
an input connected to the third element of the second planetary;
an output connected to the third element of the first planetary; and
wherein the hydrostatic transmission has first and second hydrostatic units wherein the second hydrostatic unit is connected to the input and the third element of the second planetary.

3. The hydromechanical transmission of claim 1 further comprising a reverse clutch connected to the first element of the second planetary and a ground.

4. The hydromechanical transmission of claim 1 wherein the second clutch is connected to the third element of the second planetary.

5. The hydromechanical transmission of claim 1 further comprising a third clutch connected to the first planetary that is sequentially engaged in association with the first and second clutches to create a third forward operating mode.

6. The hydromechanical transmission of claim 1 further comprising an engine providing an input directly connected to the second planetary.

7. The hydromechanical transmission of claim 1 further comprising a third planetary having first, second and third elements wherein the first element of the third planetary is connected to the third element of the first planetary, the second element of the third planetary is connected to the second element of the first planetary with a third clutch and the third element of the third planetary is connected to an input.

8. A hydromechanical transmission comprising:
a hydrostatic transmission having first and second rotational shafts;
a first planetary having first, second and third elements wherein the first rotational shaft is connected to the second element of the first planetary;
said second rotational shaft connected to an input;
a second planetary having first, second and third elements wherein the third element of the second planetary is connected to the input;
a first, second and reverse clutch connected to the first element of the second planetary such that when selectively engaged the first, second and reverse clutches create first, second and third forward operating modes each having a continuous ratio.

9. The hydromechanical transmission of claim 8 further comprising an output connected to the third element of the first planetary.

10. The hydromechanical transmission of claim 8 wherein the first clutch is connected to the third element of the first planetary.

11. The hydromechanical transmission of claim 8 wherein the reverse clutch is connected with ground.

12. The hydromechanical transmission of claim 8 wherein the reverse clutch is connected to the third element of the first planetary with a reducing gear.

13. The hydromechanical transmission of claim 8 wherein the first element of the first planetary is connected to the second element of the second planetary.

14. The hydromechanical transmission of claim 8 wherein the second clutch is additionally connected to the third element of the second planetary.

15. The hydromechanical transmission of claim 8 further comprising:
a third planetary having first, second and third elements wherein the third element of the third planetary is connected to the third element of the second planetary, the first element of the third planetary is connected to the third element of the first planetary; and
a third clutch between the second element of the third planetary and the second element of the first planetary.

16. The hydromechanical transmission of claim 15 wherein there is a negative ratio between the first element of the third planetary and the third element of the first planetary, and a positive ratio between the second element of the third planetary and the second element of the first planetary.

17. The hydromechanical transmission of claim 8 wherein the hydrostatic transmission comprises a variable unit and a fixed unit wherein the variable unit changes displacement from a starting displacement to a negative of the starting displacement in the first, second and third forward operating modes.

18. The hydromechanical transmission of claim 17 wherein the variable unit does not change displacement during a mode change.

19. A hydromechanical transmission comprising:
an input having an input center line and an output having an output center line parallel to the input centerline;
a first planetary having a first, second and third elements wherein the output is connected to the first planetary;
a second planetary located on the input center line and having first, second and third elements wherein the third element of the second planetary is connected to the input; and
first, second and reverse clutches connected to the second planetary such that when sequentially engaged first, second and third forward operating modes with continuous ratios are created.

20. The hydromechanical transmission of claim 19 wherein the second element of the second planetary is connected to the first element of the first planetary.

21. The hydromechanical transmission of claim 19 wherein the first, second and reverse clutches are adjacent.

22. The hydromechanical transmission of claim 19 wherein the input extends through the transmission for a power takeoff.

23. The hydromechanical transmission of claim 19 wherein the output extends through the transmission to provide drive at both ends of the transmission.

24. The hydromechanical transmission of claim 19 wherein at least one of the elements of the first and second planetaries is a sun gear having a speed that is greater than speeds of the other elements.

25. The hydromechanical transmission of claim 19 wherein the reverse clutch connects the third element of the first planetary with the first element of the second planetary and a reduction gear.

26. The hydromechanical transmission of claim 19 wherein a third planetary is located on the output center line and has first, second and third elements wherein the third element of the third planetary is connected to the input, the second element of the third planetary is connected to the second element of the first planetary with a third clutch and the first element of the third planetary is connected to the third element of the first planetary.
